(19) United States
(12) Patent Application Publication
(10) Pub. No.: US 2017/0280000 A1
(43) Pub. Date: Sep. 28, 2017

(54) PRINTER, METHOD OF PRINTING, AND COMPUTER-READABLE STORAGE MEDIUM

(71) Applicant: CASIO COMPUTER CO., LTD., Tokyo (JP)

(72) Inventor: Atsushi SUKENORI, Tokyo (JP)

(73) Assignee: CASIO COMPUTER CO., LTD., Tokyo (JP)

(21) Appl. No.: 15/466,601

(22) Filed: Mar. 22, 2017

(30) Foreign Application Priority Data
Mar. 24, 2016 (JP) 2016-059859
Mar. 7, 2017 (JP) 2017-042399

(51) Int. Cl. H04N 1/23; H04N 1/00

(52) U.S. Cl. CPC H04N 1/233; H04N 1/00816; H04N 2201/0096

(57) ABSTRACT

In one aspect, the present disclosure provides a printer including a controller that controls a printing unit, the controller executing: a movement distance measuring process that measures a movement distance of the printing unit relative to a printing medium; a coordinate recording process that calculates a plurality of coordinates on the basis of the movement distance measured in the movement distance measuring process; a printing region setting process that sets a printing region on the basis of the plurality of the coordinates recorded in a memory in the coordinate recording process; and a printing image selection process that identifies an image that has the largest area from at least one image, the at least one image being extracted from a group of images pre-recorded in the storage unit by designating such images that fit within the printing region set by the printing region setting process.

### BACKGROUND OF THE INVENTION

### Field of the Invention

The present invention relates to a printer, a method of printing, and a computer-readable storage medium.

Japanese Patent Application Laid-Open Publication No. 2006-341604 discloses a handheld printer that includes a navigation subsystem for tracking the movement of the handheld printer on a printing surface and a print head controller for propelling ink from a print head onto the printing surface in accordance with the movement of the handheld printer and an image stored in an image buffer.

The handheld printer disclosed in Patent Document 1 determines the boundaries of a printing region as the printer is moved by a user and scales and prints the image to fit within those boundaries.

The handheld printer disclosed in Japanese Patent Application Laid-Open Publication No. 2006-341604 makes it possible to set the boundaries of the printing region and then scale and print the image to fit within that printing region.

However, if the original image is small relative to the printing region, the enlarged image will appear distorted. Similarly, if the original image is large relative to the printing region, the reduced image will appear blurry.

Conventional printers (handheld printers) thus suffer from a problem in which the image quality of an image deteriorates when attempting to print that image in the printing region of a printing medium.

The present invention was made in view of the abovementioned problems and aims to provide a printer, a method of printing, and a computer-readable storage medium that make it possible to extract, from a plurality of pre-arranged images, an image that can be printed in a printing region defined on a printing medium such that the image is printed as large as possible without expanding or shrinking the image. Accordingly, the present invention is directed to a scheme that substantially obviates one or more of the problems due to limitations and disadvantages of the related art.

### SUMMARY OF THE INVENTION

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a controller for controlling a printing unit of a printer, the controller performing: a movement distance measuring process that measures a movement distance of the printing unit relative to a printing medium on the basis of signals received from a movement distance sensor in the printer; a coordinate recording process that calculates a plurality of coordinates on the basis of the movement distance measured in the movement distance measuring process and records the coordinates in a memory in the printer; a printing region setting process that sets a printing region on the basis of the plurality of the coordinates recorded in the storage unit in the coordinate recording process; and a printing image selection process that identifies an image that has the largest area from at least one image, the at least one image being extracted from a group of images pre-recorded in the storage unit by designating such images that fit within the printing region set by the printing region setting process.

In another aspect, the present disclosure provides a method of selecting a printing image to be executed by a controller for controlling a printing unit of a printer, including: a movement distance measuring process that measures a movement distance of a printing unit relative to a printing medium on the basis of signals received from a movement distance sensor in the printer; a coordinate recording process that calculates a plurality of coordinates on the basis of the movement distances measured in the movement distance measuring process and records the coordinates in a memory in the printer; a printing region setting process that sets a printing region on the basis of the plurality of the coordinates recorded in the storage unit in the coordinate recording process; and a printing image selection process that identifies an image that has the largest area from at least one image, the at least one image being extracted from a group of images pre-recorded in the storage unit by designating such images that fit within the printing region set by the printing region setting process.

In another aspect, the present disclosure provides a non-transitory storage medium that stores instructions executable by a controller for controlling a printing unit of a printer, the instructions causing the controller to execute the following: a movement distance measuring process that measures a movement distance of the printing unit relative to a printing medium on the basis of signals received from a movement distance sensor in the printer; a coordinate recording process that calculates a plurality of coordinates on the basis of the movement distance measured in the movement distance measuring process and stores the coordinates in a memory in the printer; a printing region setting process that sets a printing region on the basis of the plurality of the coordinates recorded in the storage unit in the coordinate recording process; and a printing image selection process that identifies an image that has the largest area from at least one image, the at least one image being extracted from a group of images pre-recorded in the storage unit by designating such images that fit within the printing region set by the printing region setting process.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter. It is to be understood that both the foregoing general description and the following detailed description are exemplary and explanatory, and are intended to provide further explanation of the invention as claimed.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1A is a side view of a printer according to one embodiment, and FIG. 1B is a bottom view of a printer according to one embodiment.

FIG. 2 is a block diagram illustrating a configuration of the printer according to one embodiment.

FIG. 3 is a plan view illustrating how a user can move the printer according to one embodiment to set a printing region.

FIG. 4 is a plan view illustrating a coordinate system set by a coordinate recording unit according to one embodiment.

FIG. 5 is a plan view illustrating coordinates stored by the coordinate recording unit according to one embodiment.

FIG. 6 is a plan view illustrating coordinates stored by a storage unit and a printing region set by a printing region setting unit according to one embodiment.

FIG. 7 is a flowchart of a printing region setting process according to one embodiment.

FIG. 8 is a flowchart of a printing image selection process according to one embodiment.

FIGS. 9A to 9F illustrate images to be printed and printing regions stored by a storage unit according to one embodiment.

FIG. 10A is a plan view illustrating an image to be printed in one embodiment, FIG. 10B is a plan view illustrating a previously printed region in one embodiment, and FIG. 10C is a plan view illustrating an image printed by a printer according to one embodiment.

FIG. 11 is a flowchart of a printing process according to one embodiment.

FIG. 12A is a side view of a printer according to a modification example, and FIG. 12B is a bottom view of the printer according to the modification example.

FIG. 13A is a plan view illustrating directions along two adjacent sides in which the user can move the printer according to the modification example, FIG. 13B is a plan view illustrating directions along two facing sides and a diagonal in which the user can move the printer according to the modification example, and FIG. 13C is a plan view illustrating a direction just along a diagonal in which the user can move the printer according to the modification example.

FIG. 14 is a plan view illustrating a coordinate system set by a coordinate recording unit according to the modification example.

### EMBODIMENT

Next, a printer 1 according to one embodiment will be described with reference to figures. Note that the same reference characters are used for components that are the same or equivalent in the figures.

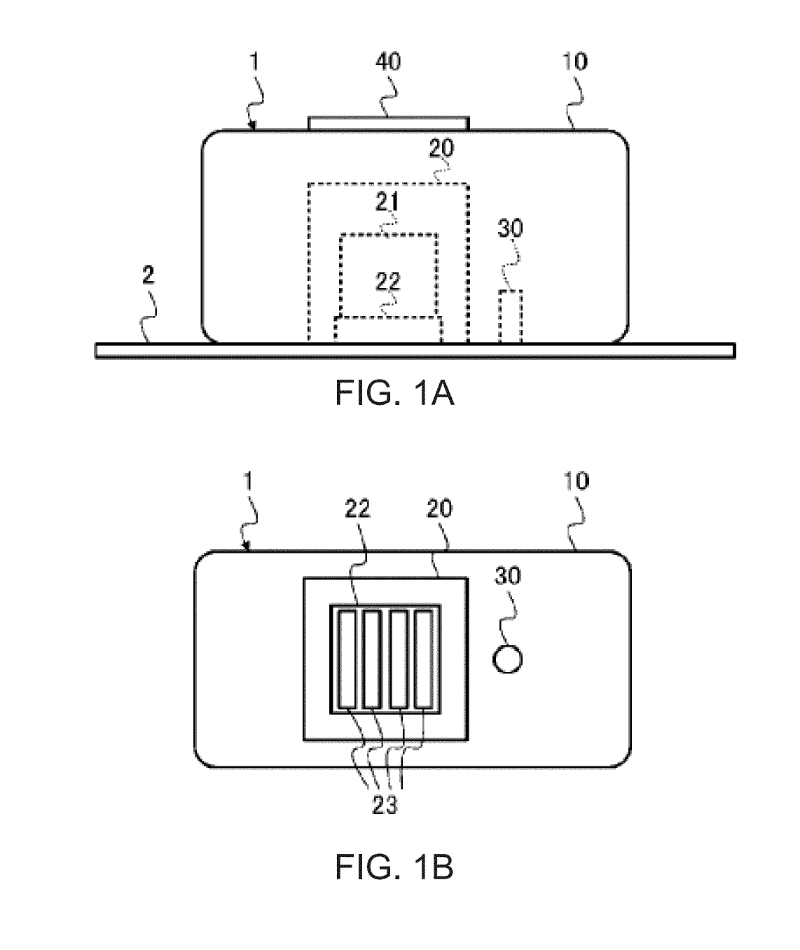

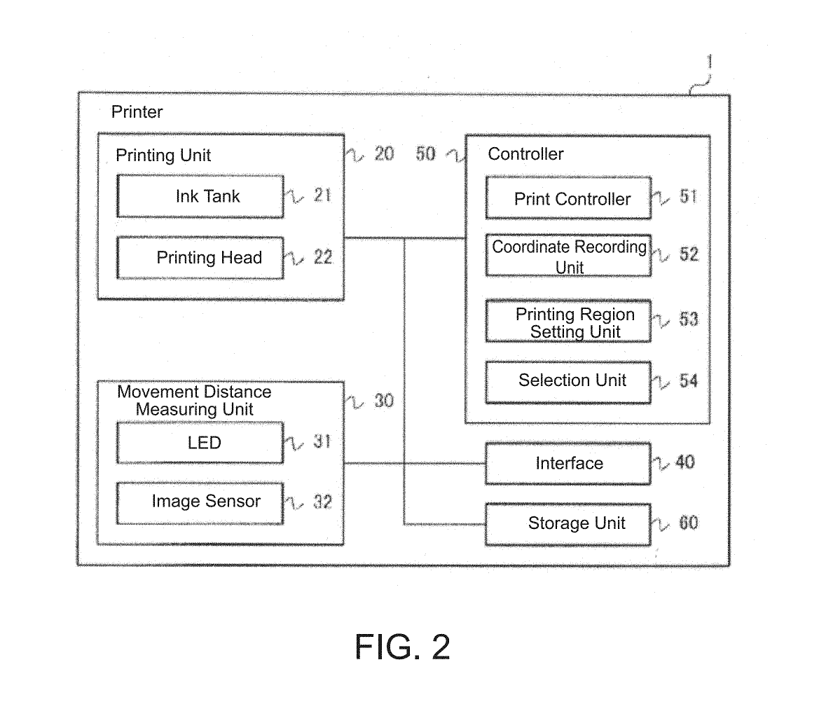

FIGS. 1A and 1B are a side view and a bottom view, respectively, of the printer 1 according to one embodiment. FIG. 2 is a block diagram illustrating a configuration of the printer 1. The printer 1 is a manual scanning printer that a user can move in a sliding manner over a printing medium 2 in order to print an image to be printed (a print image) onto that printing medium. This type of manual scanning printer is also known as a handheld printer or a direct printer.

The printing medium 2 may be printing paper, printing labels, or cardboard, for example, but is not limited to these examples. The printing medium 2 is also known as a recording medium or a printing object. Here, the printing medium 2 is made of paper and a resin, but the printing medium 2 may be any object in which a material that can accept ink is formed so as to provide a surface that can accept ink.

The images to be printed may be characters, symbols, graphics, patterns, pictures, or photographs, for example, but are not limited to these examples. The images to be printed are also known as print images or print patterns.

As illustrated in FIGS. 1A and 1B and FIG. 2, the printer 1 according to one embodiment includes a case 10, a printing unit 20, a movement distance measuring unit 30, an interface 40, a controller 50, and a storage unit 60. The storage unit 60 may be a computer-readable storage medium such as a read-only memory (ROM) or a random-access memory (RAM), for example, but is not limited to these examples.

The case 10 provides a space in which to arrange the components of the printer 1 such as the case 10, the printing unit 20, the movement distance measuring unit 30, the interface 40, the controller 50, and the storage unit 60. As illustrated in FIGS. 1A and 1B, the printing unit 20, the movement distance measuring unit 30, and the interface 40 are exposed from the case 10. Here, the case 10 is made of a resin or a metal but is not limited to being made of these materials. The case 10 is also known as a device case 10.

The printing unit 20 is fixed on the bottom surface of the case 10 and prints the images to be printed onto the printing medium 2. The printing unit 20 prints using an inkjet technology and includes an ink tank 21 that is filled with ink and a printing head 22 that dispenses droplets of the ink in the ink tank 21. The ink tank 21 supplies ink to the printing head 22. The printing head 22 includes a plurality of nozzles 23 arranged running in a primary scanning direction and in a secondary scanning direction. In the printing head 22, heaters inside of the nozzles 23 apply heat to the ink to form vapor bubbles, and the formation of these vapor bubbles causes the ink to be propelled from the nozzles 23 onto the printing medium 2. The ink may also be propelled using another method or technique that does not require application of heat.

The movement distance measuring unit 30 is a sensor that measures the amount of relative movement of the printer 1 and the printing unit 20 of the printer 1 relative to the printing medium 2. As illustrated in FIG. 2, the movement distance measuring unit 30 includes a light-emitting diode (LED) 31 and an image sensor 32, and the image sensor 32 detects light that reflects off of the printing medium 2 when the LED 31 is illuminated. The movement distance measuring unit 30 then compares the reflected light from before and after movement to measure the movement distance and the movement direction of the printer 1. The movement distance measuring unit 30 then sends data that includes the measured movement distance and movement direction to the controller 50.

The interface 40 accepts user input such as instructions to start printing, stop printing, start setting a printing region, or stop setting a printing region and also provides information to the user. The interface 40 sends any received instructions to start printing or stop printing to the controller 50 and provides any information received from the controller 50 to the user. The interface 40 may be buttons, keys, or a touch pad for accepting user input and a liquid crystal display or speakers for providing information to the user (or a touch panel that handles both), for example, but is not limited to these examples.

The controller 50 is a processor that executes a program to control the printer 1. The controller 50 includes a printing controller 51, a coordinate recording unit 52, a printing region setting unit 53, and a selection unit 54. The controller 50 may be a central processing unit (CPU), for example, but is not limited to this example.

When the interface 40 receives an instruction to start printing, the printing controller 51 obtains the printing start instruction information from the interface 40 and then controls the printing unit 20 in order to start printing. At this time, the user takes hold of the case 10 and begins to move the printer 1 in order to begin printing. The printing controller 51 then gets the movement distance measured by the movement distance measuring unit 30 and controls the printing unit 20 in order to print the portion of the print image corresponding to the current position of the printing unit 20. Once the entire print image has been printed, the printing controller 51 controls the printing unit 20 in order to stop printing.

When the interface 40 receives an instruction to start setting a printing region, the coordinate recording unit 52 obtains the information for the instruction to start setting the printing region from the interface 40 and then starts recording a plurality of coordinates starting from the current position of the printing unit 20 (a starting point P0).

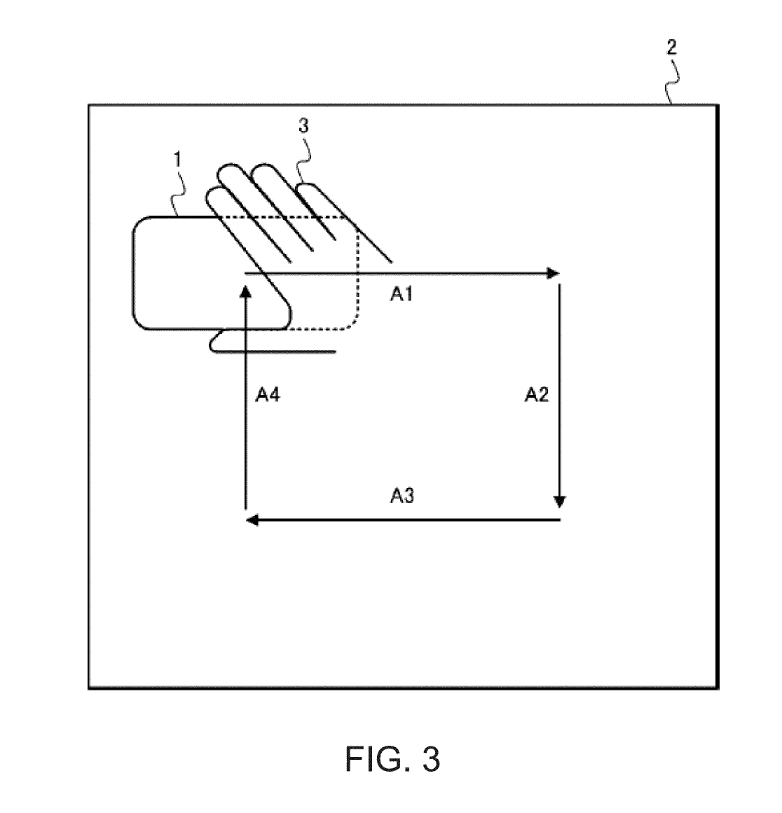

FIG. 3 is a plan view illustrating how a user can move the printer 1 to set a printing region. As illustrated in FIG. 3, the user's hand 3 grasps the printer 1 and moves the printer 1 over the printing medium 2 in the directions indicated by the arrows A1, A2, A3, and A4 in order to trace out a rectangle. The coordinate recording unit 52 gets the movement distance measured by the movement distance measuring unit 30 over a time period of ΔT seconds, calculates the coordinates P1 of the printing unit 20 at ΔT seconds after the printing region began to be set, and then stores those coordinates in the storage unit 60. Similarly, the coordinate recording unit 52 stores the coordinates P2 of the printing unit 20 at ΔT seconds after the record for the coordinates P1 in the storage unit 60. This process is repeated until the interface 40 receives an instruction to stop setting the printing region, at which point the coordinate recording unit 52 stores the current position of the printing unit 20 in the storage unit 60 as the coordinates of an ending point Pn and then stops recording the coordinates of the printing unit 20.

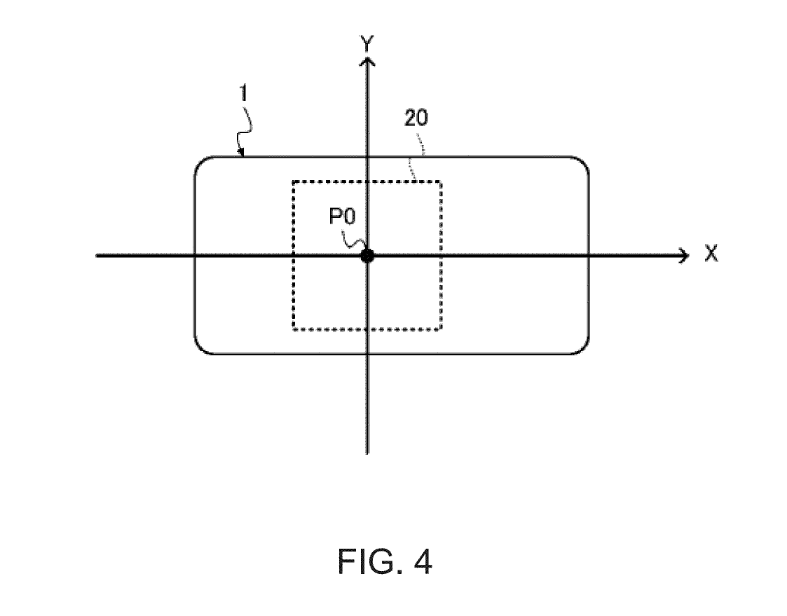

Next, the method used by the coordinate recording unit 52 to calculate the coordinates will be described in more detail. FIG. 4 is a plan view illustrating a coordinate system set by the coordinate recording unit 52. As illustrated in FIG. 4, upon receiving the information for the instruction to start setting the printing region from the interface 40, the coordinate recording unit 52 sets up a coordinate system in which the center of the printing unit 20 is the origin, the forward direction of the printer 1 is the positive X axis direction, and a straight line that is parallel to the printing medium 2 and orthogonal to the X axis is the Y axis. The coordinate recording unit 52 then sets the origin (0, 0) as the starting point P0.

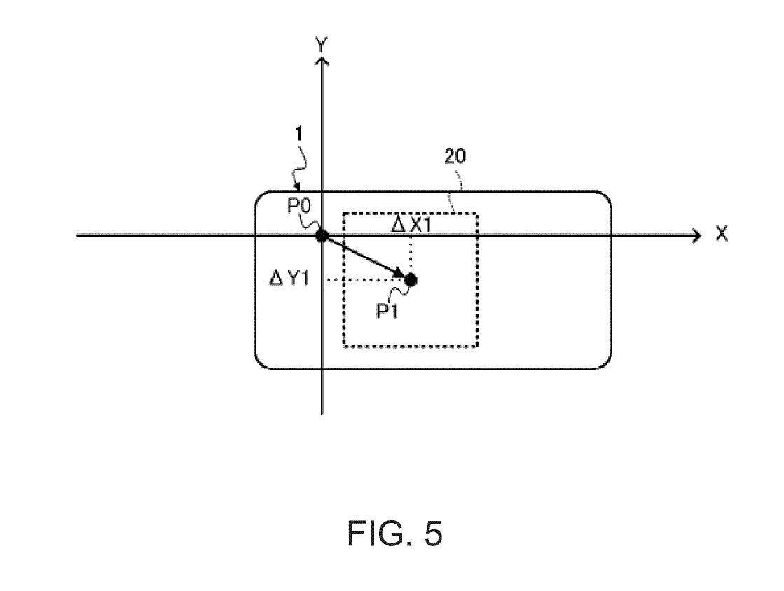

FIG. 5 is a plan view illustrating the coordinates recorded by the coordinate recording unit 52. As illustrated in FIG. 5, the coordinate recording unit 52 gets the movement distance ΔX1 in the X axis direction and the movement distance ΔY1 in the Y axis direction as measured by the movement distance measuring unit 30 at the time ΔT after the measurement started then uses those movement distances to calculate the coordinates of the point P1 at the time ΔT. The coordinates of the point P1 are thus (0+ΔX1, 0+ΔY1)=(ΔX1, ΔY1). The storage unit 52 then stores the calculated coordinates in the storage unit 60. This process is repeated to get the movement distances measured by the movement distance measuring unit 30 after each ΔT seconds, calculate the corresponding positions of the printing unit 20, and store the coordinates of the calculated points P0, P1, . . . , and Pn in the storage unit 60. Here, n is an integer that represents the number of points (not including the starting point P0) for which the coordinate recording unit 52 calculated coordinates.

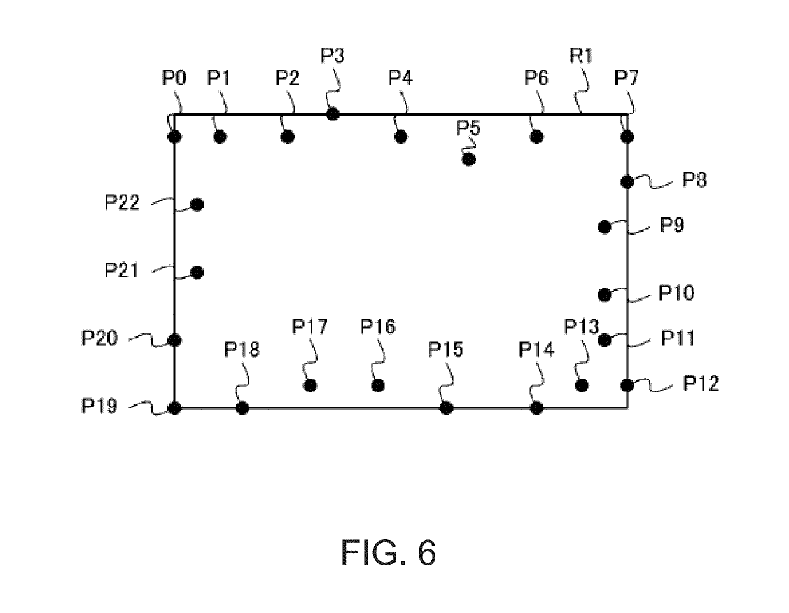

The printing region setting unit 53 then sets the printing region according to the plurality of coordinates recorded by the coordinate recording unit 52. FIG. 6 is a plan view illustrating the coordinates stored in the storage unit 60 and the printing region set by the printing region setting unit 53. Note that in the example in FIG. 6, n=22. As illustrated in FIG. 6, the printing region setting unit 53 gets the coordinates of the points P0, P1, . . . , and P22 that are stored in the storage unit 60 and sets the smallest rectangle R1 that bounds all of those points as the printing region.

Next, the method used by the printing region setting unit 53 to set the rectangle R1 as the printing region will be described in more detail. The printing region setting unit 53 extracts, from the coordinates of the points P0, P1, . . . , and Pn stored in the storage unit 60 by the coordinate recording unit 52, the X coordinate with the maximum value Xmax, the X coordinate with the minimum value Xmin, the Y coordinate with the maximum value Ymax, and the Y coordinate with the minimum value Ymin. The printing region setting unit 53 then sets the rectangle bounded by the four straight lines X=Xmin, X=Xmax, Y=Ymin, and Y=Ymax as the printing region R1. Setting the printing region in this way makes it possible to set the smallest rectangle R1 that bounds all of the points P0, P1, . . . , and P22 as the printing region.

The printing controller 51 prints when the position of the printing unit 20 is inside of the printing region R1 set by the printing region setting unit 53 and does not print if the position of the printing unit 20 is outside of the printing region R1.

The storage unit 60 stores programs and data used when the controller 50 executes processes and functions as a working region for when the controller 50 is executing processes. The storage unit 60 can store a program for controlling the printing unit 20 in order to print, a program for controlling the movement distance measuring unit 30 in order to measure movement distances, a program for setting the printing region, the coordinates of the printing unit 20, and data corresponding to the images to be printed, for example, but is not limited to storing these examples. The storage unit 60 may be a read-only memory (ROM) or a random-access memory (RAM), for example, but is not limited to these examples.

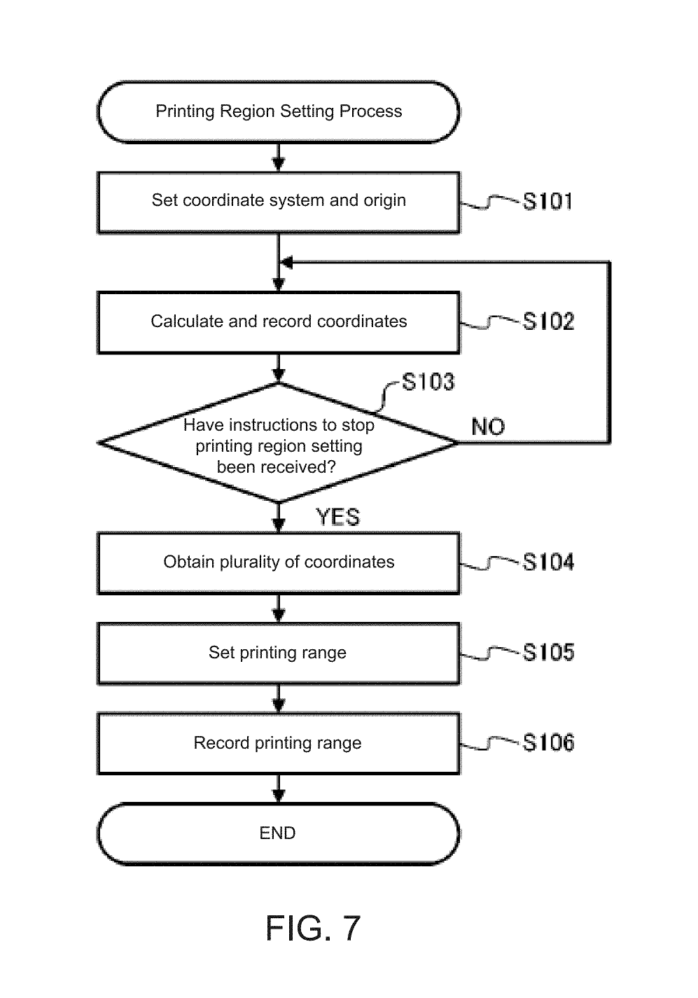

FIG. 7 is a flowchart of a printing region setting process according to one embodiment. Next, the printing region setting process executed by the printer 1 according to one embodiment will be described with reference to the flowchart in FIG. 7.

The printing region setting process begins when the interface 40 receives an instruction to start setting a printing region from the user and the controller 50 gets that instruction to start setting the printing region from the interface 40. Then, in step S101, the coordinate recording unit 52 sets up the coordinate system in which the current position of the printing unit 20 is the origin and stores the origin in the storage unit 60 as the starting point P0.

In this state, once the user moves the printer 1, the process proceeds to step S102, where the coordinate recording unit 52 gets the movement distances measured by the movement distance measuring unit 30, calculates the current coordinates of the printing head 20 based on the pre-movement position and the retrieved movement distances, and then stores those coordinates in the storage unit 60.

After the coordinates are stored in the storage unit 60, the process proceeds to step S103, where the coordinate recording unit 52 determines whether the interface 40 has received an instruction to stop setting the printing region and whether that instruction to stop setting the printing region has been retrieved from the interface 40. If it is determined that no stop instruction has been retrieved (NO in step S103), the process returns to step S102. Note that the coordinates of the position at which the instruction to start setting the printing region was received (the starting point P0) do not necessarily have to be exactly the same as the coordinates of the position at which the instruction to stop setting the printing region is received.

If it is determined that a stop instruction has been received (YES in step S103), the process proceeds to step S104, where the printing region setting unit 53 gets the plurality of stored coordinates from the storage unit 60.

Once the plurality of coordinates have been retrieved, the process proceeds to step S105, where the printing region setting unit 53 calculates the smallest rectangle R1 that bounds all of those coordinates and sets that rectangle R1 as the printing region.

Once the rectangle R1 has been calculated and set as the printing region, the process proceeds to step S106, where the printing region setting unit 53 stores the printing region in the storage unit 60, thus ending the printing region setting process.

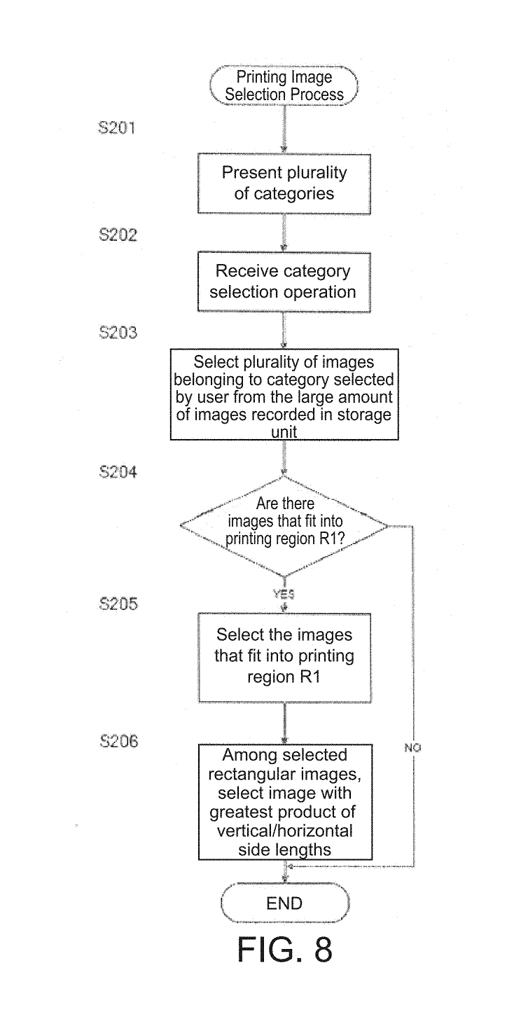

FIG. 8 is a flowchart of a printing image selection process according to one embodiment. The printing image selection process executed by the printer 1 according to one embodiment will be described with reference to the flowchart in FIG. 8. The printer 1 selects, from a plurality of pre-arranged images, an image that is suitable for a printing region as the printing image.

In one embodiment, a storage unit 60 stores a plurality of images each containing at least one of either a character string or design and expressing similar content to one another, with at least one of either the size or shape of each of the plurality of images being different from the other images. The plurality of images may be predefined images from the manufacturer of the printer 1, or alternatively may be images created by the user via the printer 1. “Similar content to one another” as described above means that the images may express a “compliment,” for example. Specifically, a plurality of images containing at least one of either a character string expressing a compliment such as “Very good!” or a design such as one showing a thumbs-up gesture express similar content to one another and are thus stored in the storage unit 60 and defined as one group of a plurality of images. Furthermore, a plurality of images defined as a group of images in this manner are stored in a plurality of groups in the storage unit 60. The plurality of images contained in the other groups express content other than compliments, such as “urgent/ASAP,” for example. Alternatively, the groups may contain differing images.

As shown in FIG. 2, a controller 50 of the printer 1 includes the selection unit 54. In accordance with user operation, the selection unit 54 extracts, from among the plurality of images stored in the storage unit 60, a group of images expressing the content chosen by the user, and the selection unit then selects, from the extracted group of images, the image that has the greatest area and will fit within a printing region R1 set by a printing region setting unit 53, and then sets that image as the printing image.

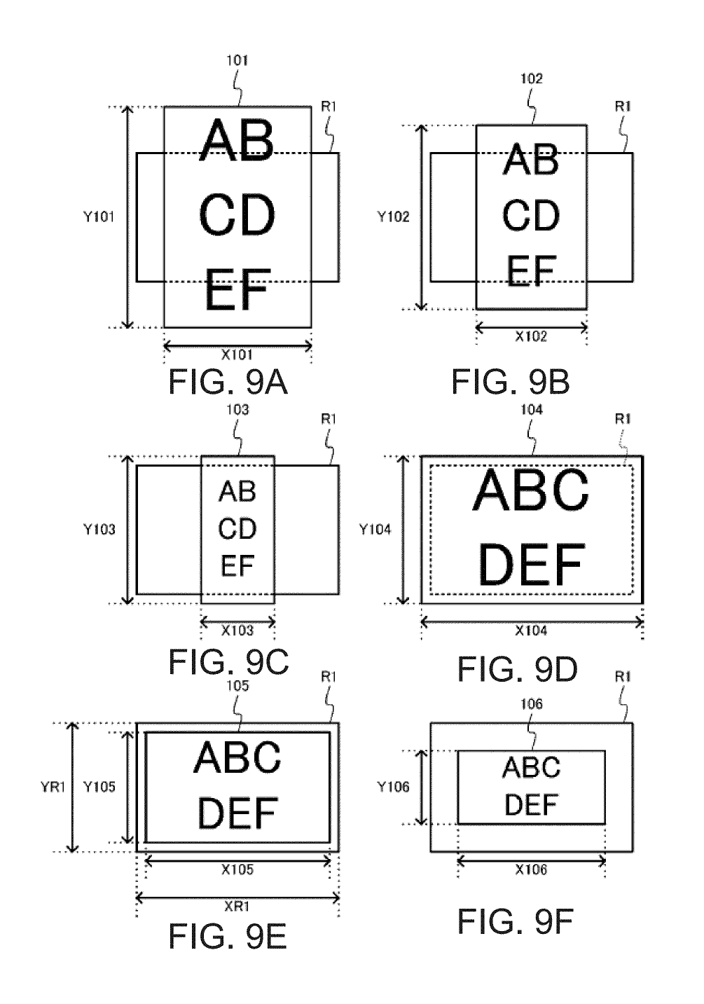

Next, the method used by the selection unit 54 to set the printing image will be described with reference to figures. FIGS. 9A to 9F illustrate printing images and printing regions stored in the storage unit 60. As illustrated in FIGS. 9A to 9F, the storage unit 60 stores six rectangular images 101 to 106 that have different sizes. The lengths of the images 101 to 106 in the X axis direction are X101, X102, . . . , and X106, respectively, and the lengths in the Y axis direction are Y101, Y102, . . . , and Y106, respectively. The specific expressions (character strings, designs, etc.) of these six rectangular images is omitted for simplicity, but all six images express a compliment, and are defined as one group of images in the storage unit 60. Moreover, all six of these rectangular images are rectangular in shape.

The selection unit 54 starts the printing image selection process upon a pre-determined operation by the user via the interface 40. The selection unit 54 presents a plurality of categories that the user can print on the interface 40 (step S201) and receives an operation selecting one of the categories from the user via the interface 40 (step S202). The categories are each designated based on similar content, as described above. The selection unit 54 organizes and displays text such as “compliment” or “urgent/ASAP,” for example, thereby presenting the plurality of categories. The selection unit 54, upon receiving from the user the operation selecting one category, selects a plurality of images belonging to the one selected category, or namely, the six rectangular images expressing a “compliment,” as described above (step S203). At this time, the selected images are no longer presented by the interface 40.

In regard to all images selected in step S203 above, the selection unit 54 compares the length XR1 of the printing region R1 in the X axis direction to the lengths of the respective images 101, . . . , 106 in the X axis direction, and compares the length YR1 of the printing region R1 in the Y axis direction to the lengths of the respective images 101, . . . , 106 in the Y axis direction (step S204). Then, the selection unit 54 selects all of the images for which the length in the X axis direction is less than or equal to XR1 and the length in the Y axis direction is less than or equal to YR1 (step S204: YES, step S205). In the example illustrated in FIGS. 9A to 9F, the image 105 in FIG. 9E and the image 106 in FIG. 9F are selected. In this manner, the images fitting within the printing region R1 are selected from a group of images pre-stored in the storage unit 60. On the other hand, if all of the images selected in step S203 have lengths in the X-axis direction exceeding XR1, or lengths in the Y-axis direction exceeding YR1, i.e., if there are no images fitting within the printing region R1 stored in the storage unit 60, then the selection unit 54 outputs an error via the interface 40 and ends the printing image selection process (step S204: NO).

From the one or more images fitting within the printing region R1, the selection unit 54 compares the areas of the selected images, i.e., the products of the respective lengths in the X axis direction and the Y axis direction, selects the image with the greatest area, and sets that image as the printing image (step S206). In the example illustrated in FIGS. 9A to 9F, the image 105 in FIG. 9E is selected and set as the printing image.

Configuring the printer 1 according to one embodiment as described above and executing the printing region setting process and the printing image selection process as described above makes it possible to extract, from a plurality of pre-arranged images, an image that can be printed in a printing region defined on a printing medium such that the image is printed as large as possible without expanding or shrinking the image.

In this manner, the printer 1 selects and prints an image of a size and shape that matches the printing region, thereby making it possible to eliminate the burden of the user having to manually select an image to print while considering the size and shape of the printing region.

Next, a printing process executed by a printer 1 according to one embodiment will be described with reference to figures. It should be noted that, during the transition from the printing range setting process to the printing process, the movement distance measuring unit 30 continues to measure a movement amount of the printer; thus, it is preferable that the surface of the printer on which the movement distance measuring unit 30 is provided not leave the printing surface of the printing medium 2.

In one embodiment, when a printing controller 51 controls a printing unit 20 in order to print the portion of a printing image corresponding to the position of the printing unit 20, those portions that have been printed are stored in a storage unit 60 as previously printed regions. The printing controller 51 then continues printing if the position of the printing unit 20 corresponds to a portion of the printing image that still needs to be printed but does not print if that portion is already stored as a previously printed region in the storage unit 60.

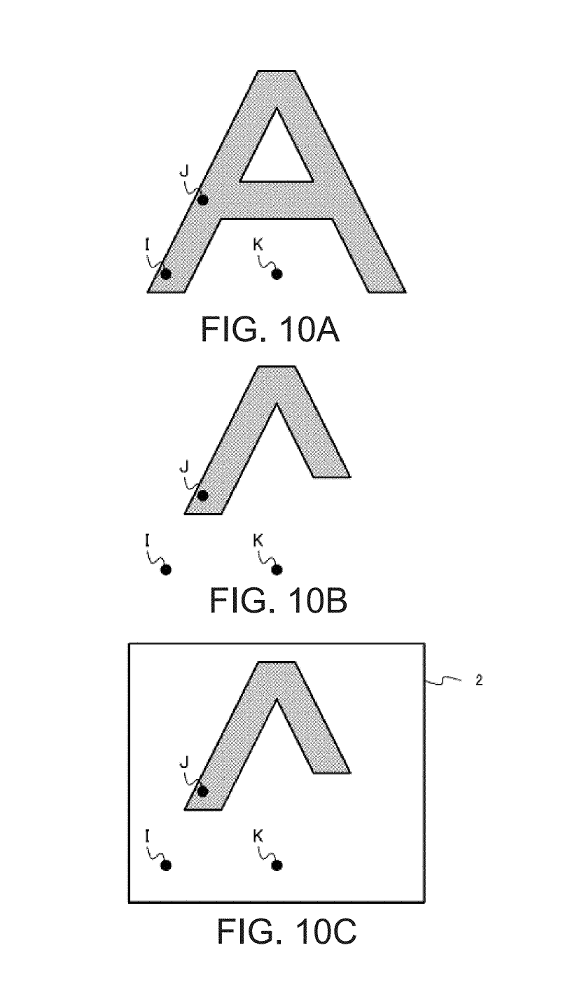

FIG. 10A is a plan view illustrating an image to be printed. FIG. 10B is a plan view illustrating a previously printed region stored in the storage unit 60 by the printing controller 51, and FIG. 10C is a plan view illustrating an image printed by the printer 1. As illustrated in FIGS. 10B and 10C, the printing controller 51 saves an image of the printed portion to the storage unit 60, and therefore the previously printed region stored in the storage unit 60 by the printing controller 51 matches the image that has actually been printed by the printer 1.

Next, the operation of the printing controller 51 at representative positions of the printing unit 20 will be described. When the position of the printing unit 20 on the printing medium 2 corresponds to the point I in FIGS. 10A, 10B, and 10C, the point I represents a portion that should be printed, as illustrated in FIG. 10A. Moreover, as illustrated in FIG. 10B, this portion has not yet been printed, and therefore the printing controller 51 controls the printing unit 20 in order to print that portion and then stores an image of that printed portion in the storage unit 60.

When the position of the printing unit 20 on the printing medium 2 corresponds to the point J in FIGS. 10A, 10B, and 10C, the point J also represents a portion that should be printed, as illustrated in FIG. 10A. However, as illustrated in FIG. 10B, this portion has already been printed, and therefore the printing controller 51 does not print anything further.

When the position of the printing unit 20 on the printing medium 2 corresponds to the point K in FIGS. 10A, 10B, and 10C, the point K represents a portion that should not be printed, as illustrated in FIG. 10A. Therefore, the printing controller 51 does not print anything.

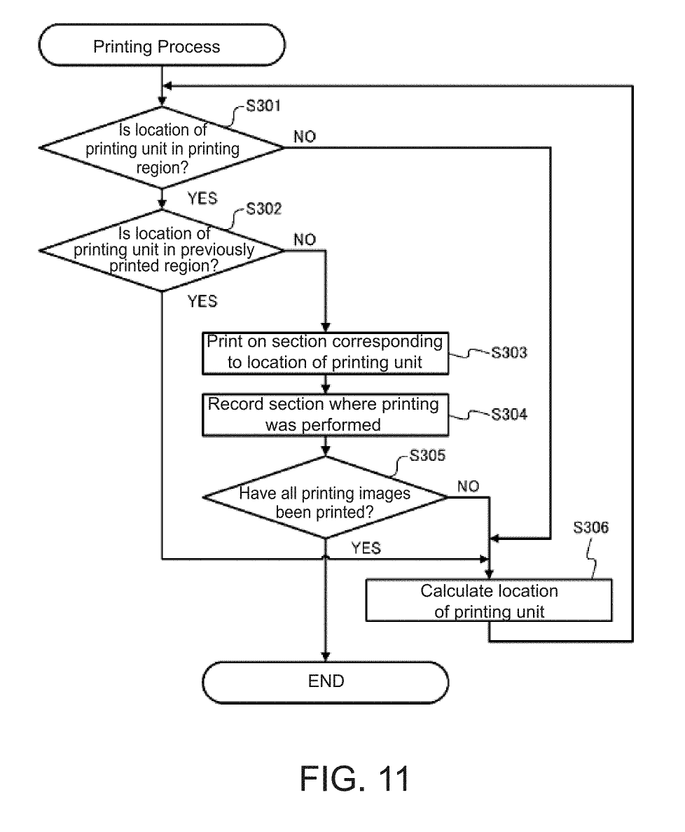

FIG. 11 is a flowchart of a printing process according to an embodiment that is executed after a printing region setting process. Next, the printing process executed by the printer 3 according to one embodiment will be described with reference to the flowchart in FIG. 11. The printing region setting process is the same as in other embodiments.

The printing process begins when an interface 40 receives an instruction to start printing from the user and a controller 50 gets that instruction to start printing from the interface 40. First, in step S301, the printing controller 51 determines whether the position of the printing unit 20 is within a rectangle R1 (the printing region).

If it is determined that the position of the printing unit 20 is within the printing region (YES in step S301), the process proceeds to step S302, where the printing controller 51 determines whether the position of the printing unit 20 is within the previously printed region.

If it is determined that the position of the printing unit 20 is not within the previously printed region (NO in step S302), the process proceeds to step S303, where the printing controller 51 controls the printing unit 20 in order to print the portion of the printing image corresponding to the position of the printing unit 20.

Once that portion has been printed, the process proceeds to step S304, where the printing controller 51 stores the portion that has been printed in the storage unit 60 as a previously printed region.

Once the previously printed region has been recorded, the process proceeds to step S305, where the printing controller 51 determines whether the entire printing image has been printed.

Once it is determined that the entire printing image has been printed (YES in step S305), the printer 1 ends the printing process.

If it is determined that the printing image has not been entirely printed yet (NO in step S305), the process proceeds to step S306, where the printing controller 51 gets the movement distances measured by a movement distance measuring unit 30 and then calculates the current position of the printing unit 20. The process then returns to step S301.

If it is determined in step S302 that the position of the printing unit 20 is not within the previously printed region (YES in step S302), the process proceeds to step S306.

If it is determined in step S301 that the position of the printing unit 20 is not within the printing region (NO in step S301), the process proceeds to step S306.

Configuring the printer 1 according to one embodiment as described above and executing the printing region setting process, the printing image extraction process, and the printing process as described above makes it possible to extract, from a plurality of pre-arranged images, an image that can be printed in a printing region defined on a printing medium such that the image is printed as large as possible without expanding or shrinking the image, and then printing the extracted image in the printing region defined on the printing medium as described above.

Furthermore, the printer 1 does not print outside of the printing region, thereby making it possible to prevent printing in locations in which the user does not want printing to occur, such as outside of the printing medium 2 or in locations where another image has already been printed. Furthermore, the printer 1 does not print again in previously printed regions, thereby making it possible to prevent wasteful usage of ink and bleeding of the ink due to repeated printing in the same location.

In addition, during the printing process itself, the user can simply focus on moving the printer 1 without having to worry about the printing region or the previously printed regions, thereby making it possible to improve the ease of using of the printer 1 during the printing process.

### Modification Example

Although an embodiment of the present invention was described above, this embodiment is only an example, and the scope of the present invention is not limited to this example. In other words, embodiments of the present invention may take a wide variety of forms, and all such embodiments are included in the scope of the present invention.

For example, in the embodiments described above, the printing unit 20 includes the ink tank 21 and the printing head 22 and prints using an inkjet technology, but the present invention is not limited to this example. The printing unit may print using any printing technology, including thermal printing or thermal transfer printing.

In the embodiments described above, the movement distance measuring unit 30 includes the LED 31 and the image sensor 32 and measures movement distances by using the image sensor 32 to detect light that reflects off of the printing medium 2 when the LED 31 is illuminated. However, the present invention is not limited to this example. The movement distance measuring unit 30 may alternatively include rollers or wheels arranged on the bottom surface of the case 10 and may measure movement distances by measuring the rotations of those rollers or wheels. Alternatively, the movement distance measuring unit 30 may include a laser light source and may measure movement distances by using the image sensor 32 to detect laser light that reflects off of the printing medium 2 when the laser light source emits light.

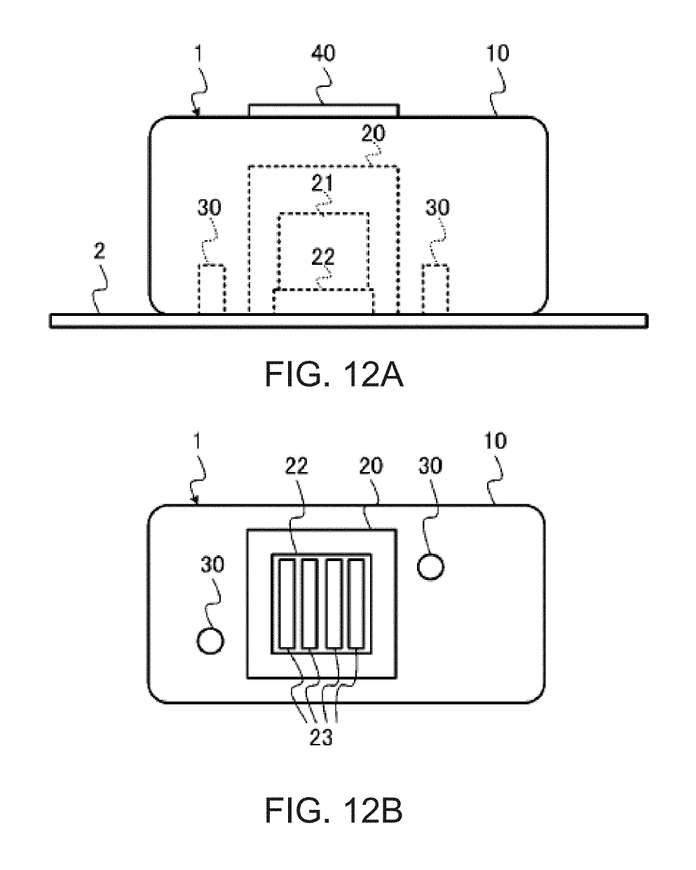

The printer 1 may include a plurality of the movement distance measuring units 30. FIGS. 12A and 12B are a side view and a bottom view, respectively, of a printer 1 according to this modification example. As illustrated in FIGS. 12A and 12B, the printer 1 according to this modification example includes two of the movement distance measuring units 30. When there is only a single movement distance measuring unit 30, changes in the orientation of the printer 1 (that is, rotations) cannot be detected. Including a plurality of the movement distance measuring units 30 makes it possible to detect changes in the orientation of the printer 1, thereby making it possible to achieve greater accuracy when setting the printing region and printing.

In one embodiment, the printer 1 ended the printing process once it was determined that the entire printing image had been printed. However, the present invention is not limited to this example. The printer 1 may alternatively control the printing unit 20 in order to end the printing process when the interface 40 receives an instruction to stop printing from the user and the controller 50 then gets the information that an instruction to stop printing was received from the interface 40.

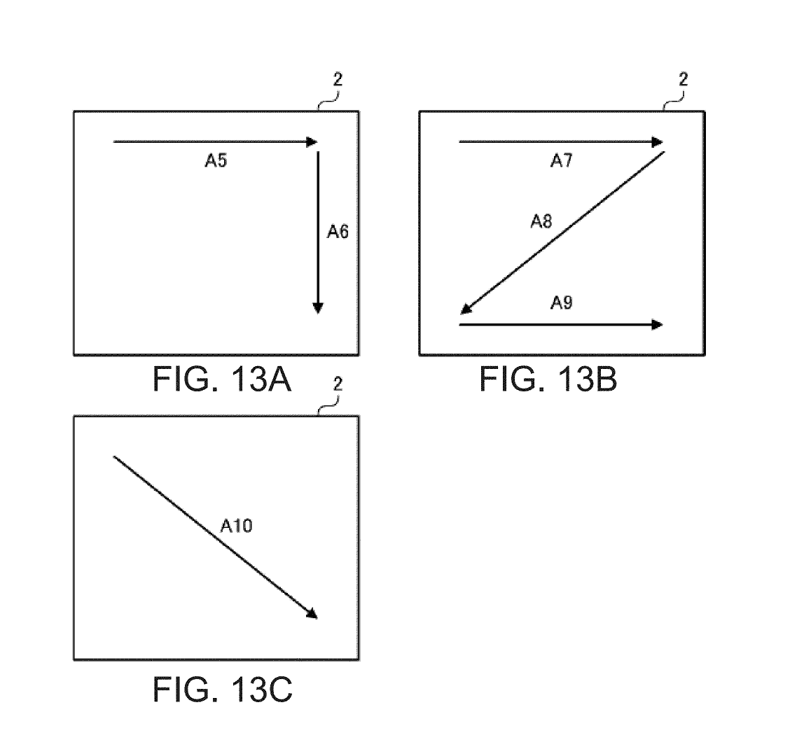

As illustrated in FIG. 3, in one embodiment the user's hand 3 grasps the printer 1 and moves the printer 1 over the printing medium 2 in the directions indicated by the arrows A1, A2, A3, and A4 in order to trace out a rectangle. However, the present invention is not limited to this example. FIGS. 13A to 13C are plan views illustrating directions in which the user can move the printer 1. As illustrated by the arrows A5 and A6 in FIG. 13A, the printer 1 may be moved along two adjacent sides of a rectangular region. As illustrated by the arrows A7, A8, and A9 in FIG. 13B, the printer 1 may also be moved along two facing sides and the diagonal of a rectangular region. As illustrated by the arrow A10 in FIG. 13C, the printer 1 may also be moved just along the diagonal of a rectangular region. In each of these examples, the printing region setting unit 53 can get the coordinates of points in the same manner as in one embodiment and then calculate the smallest rectangle R1 that bounds all of those points in order to set the printing region.

In one embodiment, the printing region setting unit 53 gets the coordinates of all of the points and then calculates the smallest rectangle R1 that bounds all of those points in order make it possible to set the printing region. However, the present invention is not limited to this example. The largest rectangle R2 that does not include any of the recorded points may be calculated and set as the printing region instead. Alternatively, a rectangle R3 that is smaller than the rectangle R1 but larger than the rectangle R2 may be calculated and set as the printing region.

In one embodiment, the printing region setting unit 53 sets a rectangular printing region, but the present invention is not limited to this example. The printing region setting unit 53 may alternatively set a circular, elliptical, or polygon-shaped region or any shape bounded by straight lines or curved lines as the printing region. Alternatively, the interface 40 may present various shape options to the user in advance and receive an instruction for selecting the shape the user would like to set as the printing region, and then the printing region setting unit 53 may get the information for the selected shape in order to set the shape to use for the selected region. Moreover, the user may move the printer 1 to trace out a freehand shape to be set as the printing region.

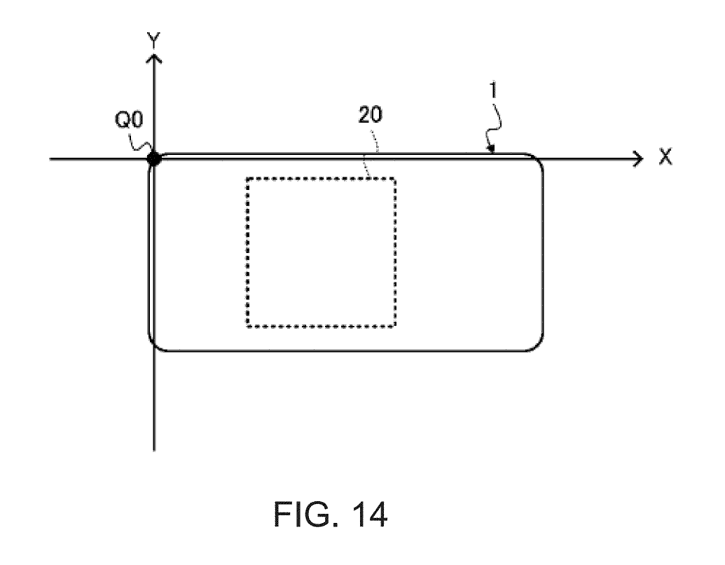

The coordinate recording unit 52 sets a coordinate system in which the center of the printing unit 20 is the origin, but the present invention is not limited to this example. FIG. 14 is a plan view illustrating a coordinate system set by the coordinate recording unit 52. As illustrated in FIG. 14, the coordinate recording unit 52 may set a coordinate system in which one of the corners Q0 of the printer 1 is the origin. When the coordinate system is configured in this manner, the storage unit 60 stores the positional relationships between Q0 and the center of the printing unit 20, and the printing controller 51 executes the printing process in accordance with the recorded positional relationships.

When the coordinate recording unit 52 sets the coordinate system illustrated in FIG. 14, the printing region setting unit 53 may set a region that includes any regions over which the case 10 of the printer 1 has been moved as the printing region. More specifically, the printing region setting unit 53 may again calculate the smallest rectangle R1 that bounds all of the recorded points, but then enlarge that rectangle R1 in the positive X axis direction and the negative Y axis direction by the width of the case 10 in the X axis direction and the width of the case 10 in the Y axis direction, respectively, and then set the resulting region as the printing region. Setting the printing region in this manner allows the user to set the printing region based on the entire case 10 of the printer 1 rather than based on a specific single point thereof, thereby making it possible to improve the ease of setting the printing region for the user. Here, the width of the case 10 in the X axis direction and the width of the case 10 in the Y axis direction are stored in the storage unit 60.

Furthermore, the present invention may be provided in the form of a printer that already includes all of the components required to achieve the features of the present invention, or an existing information processing device or the like may use programs in order to function as the printer according to the present invention. In other words, programs for implementing the features of the printers described above in one embodiment and in the modification examples may be executed by a CPU or the like for controlling an existing information processing device or the like in order to make it possible for that information processing device to function as the printer according to the present invention. Moreover, the method of printing according to the present invention may be implemented using such a printer.

In addition, such programs may be implemented and used in any manner. For example, the programs may be stored on and used from a computer-readable storage medium such as a floppy disk, a Compact Disc Read-Only Memory (CD-ROM), a Digital Versatile Disc Read-Only Memory (DVD-ROM), or a memory card. Furthermore, the programs may be superimposed onto a carrier wave and then used via a communication medium such as the internet. For example, the programs may be posted on and distributed via a bulletin board system (BBS) on a communication network. Furthermore, the programs may be launched and executed similar to other applications and programs by an operating system (OS) in order to provide a configuration that can execute the processes described above.

Preferred embodiments of the present invention were described above. However, the present invention is not limited to the embodiments described above and includes all inventions included in the scope of the claims as well as their equivalents.

The present invention was described using the specific embodiment above as an example. However, the technical scope of the present invention is not limited to the embodiment described above. The scope of the present invention is not limited to the embodiment described above, and any configurations included in the scope of the claims and their equivalents are also encompassed by the present invention.

It is understood to persons skilled in the art that various modifications or improvements can be made to the specific embodiments described above, and such modifications and improvements are included within the technical scope of the present invention as defined by the claims.

What is claimed is:

1. A controller for controlling a printing unit of a printer, the controller performing:
a movement distance measuring process that measures a movement distance of the printing unit relative to a printing medium on the basis of signals received from a movement distance sensor in the printer;
a coordinate recording process that calculates a plurality of coordinates on the basis of the movement distance measured in the movement distance measuring process and records said coordinates in a memory in the printer;
a printing region setting process that sets a printing region on the basis of the plurality of the coordinates recorded in the storage unit in the coordinate recording process; and
a printing image selection process that identifies an image that has the largest area from at least one image, the at least one image being extracted from a group of images pre-recorded in the storage unit by designating such images that fit within the printing region set by the printing region setting process.

2. The controller according to claim 1, wherein the printing region setting process sets, as the printing region, the smallest rectangle enclosing all of the plurality of coordinates recorded by the coordinate recording process.

3. The controller according to claim 1, wherein the printing region setting process sets, as the printing region, a circle, an ellipse, a polygon, or a shape bounded by straight lines or curved lines.

4. The controller according to claim 1,
wherein the controller further executes a printing process that causes the printing unit to print on the printing medium,
wherein the printing process includes:
a previously printed region storage process that causes to be stored, in the storage unit, a previously printed region on the printing medium where the printing unit has printed,
a repeat printing avoidance process that does not allow the printing unit to print when a location of the printing unit is within the printing range set by the printing range setting process and within the previously printed region stored in the storage unit.

5. A printer, comprising;
the controller according to claim 4; and
a device body housing the printing unit, the controller, and the movement distance sensor,
wherein the controller executes the movement distance measuring process, the coordinate recording process, and the printing process while the device body is being held by a user and moved over the printing medium.

6. A method of selecting a printing image to be executed by a controller for controlling a printing unit of a printer, comprising:
a movement distance measuring process that measures a movement distance of a printing unit relative to a printing medium on the basis of signals received from a movement distance sensor in the printer;
a coordinate recording process that calculates a plurality of coordinates on the basis of the movement distances measured in the movement distance measuring process and records said coordinates in a memory in the printer;
a printing region setting process that sets a printing region on the basis of the plurality of the coordinates recorded in the storage unit in the coordinate recording process; and
a printing image selection process that identifies an image that has the largest area from at least one image, the at least one image being extracted from a group of images pre-recorded in the storage unit by designating such images that fit within the printing region set by the printing region setting process.

7. The method of selecting the printing image according to claim 6, wherein the printing region setting process sets, as the printing region, the smallest rectangle enclosing all of the plurality of coordinates recorded by the coordinate recording process.

8. The method of selecting the printing image according to claim 6, wherein the printing region setting process sets, as the printing region, a circle, an ellipse, a polygon, or a shape bounded by straight lines or curved lines.

9. The method of selecting the printing image according to claim 6, further comprising:
a printing process that causes the printing unit to print on the printing medium,
wherein the printing process includes:
a previously printed region storage process that causes to be stored, in the storage unit, a previously printed region on the printing medium where the printing unit has printed,
a repeat printing avoidance process that does not allow the printing unit to print when a location of the printing unit is within the printing range set by the printing range setting process and within the previously printed region stored in the storage unit.

10. The method of selecting the printing image according to claim 9,
wherein the movement distance measuring process, the coordinate recording process, and the printing process are executed while a device body that houses the printing unit, the controller, and the movement distance sensor is being held by a user and moved over the printing medium.

11. A non-transitory storage medium that stores instructions executable by a controller for controlling a printing unit of a printer, the instructions causing the controller to execute the following:
a movement distance measuring process that measures a movement distance of the printing unit relative to a printing medium on the basis of signals received from a movement distance sensor in the printer;
a coordinate recording process that calculates a plurality of coordinates on the basis of the movement distance measured in the movement distance measuring process and stores said coordinates in a memory in the printer;
a printing region setting process that sets a printing region on the basis of the plurality of the coordinates recorded in the storage unit in the coordinate recording process; and
a printing image selection process that identifies an image that has the largest area from at least one image, the at least one image being extracted from a group of images pre-recorded in the storage unit by designating such images that fit within the printing region set by the printing region setting process.

12. The non-transitory storage medium according to claim 11, wherein the printing region setting process sets, as the printing region, the smallest rectangle enclosing all of the plurality of coordinates recorded by the coordinate recording process.

13. The non-transitory storage medium according to claim 11, wherein the printing region setting process sets, as the printing region, a circle, an ellipse, a polygon, or a shape bounded by straight lines or curved lines.

14. The non-transitory storage medium according to claim 11, wherein the processor further performs:
a printing process that causes the printing unit to print on the printing medium,
wherein the printing process includes:
a previously printed region storage process that causes to be stored, in the storage unit, a previously printed region on the printing medium where the printing unit has printed,
a repeat printing avoidance process that does not allow the printing unit to print when a location of the printing unit is within the printing range set by the printing range setting process and within the previously printed region stored in the storage unit.

15. The non-transitory storage medium according to claim 14,
wherein the movement distance measuring process, the coordinate recording process, and the printing process are executed while a device body that houses the printing unit, the controller, and the movement distance sensor is being held by a user and moved over the printing medium.

16. A printer, comprising;
the controller according to claim 1;
a user interface; and
a device body housing the printing unit, the controller, the movement distance sensor, and the storage unit, the device body having the user interface installed thereon,
wherein the controller communicates, via the user interface, to a user that the printer is in a printing region defining mode, in which the user is to specify a desired printing region within the printing medium by manually moving the device body relative to the printing medium to a plurality of locations, and
wherein the movement distance measuring process, the coordinate recording process, and the printing process are executed while the printer is in the printing region defining mode and the device body is moved over the printing medium to the plurality of locations by the user in said mode.
